(19) United States
(12) Patent Application Publication
(10) Pub. No.: US 2013/0308791 A1
(43) Pub. Date: Nov. 21, 2013

(54) APPARATUS AND METHOD FOR REDUCING AUDIBLE NOISE OF POWER SUPPLY

(71) Applicant: NEOENERGY MICROELECTRONICS, INC., Chupei City (TW)

(72) Inventors: Siang-Yu YANG, Chupei City (TW); Kuan-Sheng WANG, Chupei City (TW); Chien-Hung LIU, Chupei City (TW)

(73) Assignee: NEOENERGY MICROELECTRONICS, INC., Chupei City (TW)

(21) Appl. No.: 13/628,979

(22) Filed: Sep. 27, 2012

(30) Foreign Application Priority Data
May 17, 2012 (TW) 101117544

(51) Int. Cl. H04B 15/00

(52) U.S. Cl. 381/94.5

(57) ABSTRACT

A method for reducing audible noise of a power supply provides a PWM signal for controlling a power converter. First, a feedback voltage is produced by detecting an output voltage of the power converter. Afterward, a burst-in voltage and a burst-out voltage are set. Afterward, a voltage level of the burst-in voltage or a voltage level of the burst-out voltage is dynamically varied. Afterward, the PWM signal is switched off when the feedback voltage is less than the burst-in voltage. Final, the PWM signal is switched on when the feedback voltage is greater than the burst-out voltage.

This application is based on and claims the benefit of Taiwan Application No. 101117544 filed May 17, 2012 the entire disclosure of which is incorporated by reference herein.

### BACKGROUND

1. Technical Field

The present disclosure relates generally to an apparatus and a method for reducing audible noise, and more particularly to an apparatus and a method for reducing audible noise of a power supply.

2. Description of Related Art

The current environmental awareness is gradually being human attention so that the concept of efficient use of energy has become a consensus. In particular, the advanced countries in Europe and the U.S. increasingly strict requirements of the electrical products in no-load or light-load power consumption and recently set standard specifications for power losses.

Because the audible frequency range for human is between 20 Hz and 20,000 Hz, the switching frequency of operating the power converter in a heavy-load condition is designed to be generally more than 20 kHz so that the human cannot hear. Because switching losses and conduction losses of the power converter is closely related to the switching frequency thereof, it is usually to reduce the switching frequency to significantly reduce light-load or no-load losses. Especially, when the power converter is operated under the light-load condition or the no-load standby condition, a frequency-reducing technology, such as a burst mode scheme or a skip mode scheme, is usually introduced to reduce losses and increase efficiency.

Reference is made to FIG. 1A and FIG. 1B which are schematic waveforms of a prior art converter under a frequency reduction operation according to two embodiments. For convenience of explanation, the assumed data are exemplified for further demonstration. As shown in FIG. 1A, the abscissa represents the voltage detected from the load and the ordinate represents the operating frequency. When the power converter is operated under a heavy-load condition, the switching frequency is fixed at 65 kHz. In addition, the power converter will enter into a frequency-reducing operation when the voltage reduces to a first load voltage Vf1, such as 60% rated voltage, according to the load condition. As shown in FIG. 1A, the operating frequency is reduced from 65 kHz to 25 kHz when the voltage reduces to a second load voltage Vf2, and the switching frequency is fixed at 25 kHz. However, an uncontrolled operating frequency is produced when the load is lighter to enter into a bust mode operation, that is, the power converter is in an unstable condition. The major difference between the FIG. 1B and the FIG. 1A is that the operating frequency is almost zero Hz when the voltage reduces to the second load voltage Vf2. In brief, an audible noise problem exists in the two above-mentioned operating conditions of the power converter. Also, the problem is caused by the fixed-frequency operation of the power converter even when the load voltage reduces to the second load voltage Vf2, thus resulting in that the signal spectrum component is focused on the repeating operating frequency to generate a larger signal amplitude.

Reference is made to FIG. 2 which is a circuit block diagram of a switching power supply. In this example, the flyback converter is exemplified for further demonstration. Also, FIG. 3 is a schematic waveform of timing and voltage of controlling the converter. As shown in FIG. 2, the flyback converter is applied to a power supply. A PWM control unit 10A is electrically connected to a power switch Qs. The power switch Qs is further coupled to a primary-side winding Wpr of a transformer Tr to control the transformer Tr, thus regulating an output voltage of the power supply. In addition, the power supply further has a capacitor C1, which is coupled to an auxiliary winding Wau of the transformer Tr via a diode D1 to provide an operating voltage Vcc.

As shown in FIG. 3, the power supply starts up at a first time t1. Because the capacitor C1 is charged, the operating voltage Vcc is gradually increased. Afterward, the startup operation of the power supply is executed when the operating voltage Vcc is greater than a turned-on voltage Von at a second time t2. At this time, the PWM control unit 10A outputs a PWM control signal Vg to control the power switch Qs, thus controlling the transformer Tr. In particular, the system is not stable yet. Once the operating voltage Vcc increases to an upper-threshold voltage Vup, the capacitor Ca is not charged so that the operating voltage Vcc no longer continually increases. Afterward, the operating voltage Vcc is gradually decreased when the capacitor Ca stops being charged. At this time, the PWM control unit 10A is collectively supplied through the auxiliary winding Wau of the transformer Tr and the capacitor Ca. On the other hand, once the operating voltage Vcc decreases to a low-threshold voltage Vlow (not shown), the capacitor Ca is charged again so that the operating voltage Vcc no longer continually decreases. Afterward, the operating voltage Vcc is gradually increased when the capacitor Ca starts being charged. In addition, a normal operation of the power supply is executed when the operation voltage Vcc is not greater than the upper-threshold voltage Vup and the operation voltage Vcc is not less than the lower-threshold voltage Vlow. Under this stable condition, the PWM control unit 10A is completely supplied through the auxiliary winding Wau of the transformer Tr.

Especially, when the power converter is operated under a light-load condition or a no-load standby condition, a frequency-reducing technology, such as a burst mode scheme or a skip mode scheme, is usually introduced to reduce losses and increase efficiency. After a third time t3, the frequency of the PWM control signal Vg outputted from the PWM control unit 10A is reduced with the load reduction. The detailed description of the burst mode control scheme will be made hereinafter with reference to FIG. 4.

Reference is made to FIG. 4 which is a schematic view of a prior art burst mode scheme.

FIG. 4 shows a schematic view of variation of a feedback voltage Vfb and a corresponding PWM control signal Vg under a certain load. The feedback voltage Vfb can be detected by a photo coupler Op and the feedback voltage Vfb is varied with the load conditions. When the feedback voltage Vfb is less than a burst-in voltage Vbi because of the load reduction, the PWM control unit 10A stops outputting the PWM control signal Vg, thus disabling switching power switches to reduce output power. Accordingly, the feedback voltage Vfb gradually increases. Until the feedback voltage Vfb is greater than a burst-out voltage Vbo, the PWM control unit 10A outputs the PWM control signal Vg so that the feedback voltage Vfb gradually decreases. Accordingly, the feedback voltage Vfb is repeatedly varied between the burst-in voltage Vbi and the burst-out voltage Vbo when the power converter is operated under the light-load condition or the no-load standby condition. Also, the periods Tb are identical when the feedback voltage Vfb is between the burst-in voltage Vbi and the burst-out voltage Vbo. In other words, the corresponding frequencies are in a fixed value, resulting in that the signal spectrum component is usually focused on the repeating operating frequency to produce larger signal amplitude. Therefore, the human would feel uncomfortable if the frequency of the operating frequency falls in the frequency range that the human can hear.

Accordingly, it is desirable to provide an apparatus and a method for reducing audible noise of a power supply to disperse low-frequency operation energy of the pulse-width modulation signal to reduce audible noise of the power supply.

### SUMMARY

An object of the invention is to provide a method for reducing audible noise of a power supply to solve the above-mentioned problems.

Accordingly, the method of reducing audible noise of the power supply provides a pulse-width modulation signal to control a power converter. The method includes the following steps: (a1) an output voltage of the power converter is detected to produce a feedback voltage; (b1) a burst-in voltage and a burst-out voltage are set; (c1) a voltage level of the burst-in voltage or a voltage level of the burst-out voltage is dynamically varied; (d1) the pulse-width modulation signal is switched off when the feedback voltage is less than the burst-in voltage; and (e1) the pulse-width modulation signal is switched on when the feedback voltage is greater than the burst-out voltage.

The voltage level of the burst-in voltage or the voltage level of the burst-out voltage are dynamically varied to achieve an arbitrary duty cycle of the pulse-width modulation signal, thus dispersing low-frequency operation energy of the pulse-width modulation signal to reduce audible noise of the power supply.

Another object of the invention is to provide a method for reducing audible noise of a power supply to solve the above-mentioned problems.

Accordingly, the method of reducing audible noise of the power supply provides a pulse-width modulation signal to control a power converter. The method includes the following steps: (a2) an output voltage of the power converter is detected to produce a feedback voltage; (b2) at least two burst-out voltages and at least one burst-in voltage are set to provide a first burst-out voltage, a second burst-out voltage, and a burst-in voltage; wherein a voltage level of the burst-in voltage is less than a voltage level of the first burst-out voltage and the voltage level of the first burst-out voltage is less than a voltage level of the second burst-out voltage; (c2) the pulse-width modulation signal is switched off when the feedback voltage is less than the burst-in voltage; (d2) the pulse-width modulation signal is switched on when the feedback voltage is greater than the first burst-out voltage; and (e2) the pulse-width modulation signal is switched on when the feedback voltage is greater than the second burst-out voltage.

The voltage level of the first burst-out voltage and the voltage level of the second burst-out voltage are set to achieve an arbitrary duty cycle of the pulse-width modulation signal, thus dispersing low-frequency operation energy of the pulse-width modulation signal to reduce audible noise of the power supply.

Further another object of the invention is to provide a method for reducing audible noise of a power supply to solve the above-mentioned problems.

Accordingly, the method of reducing audible noise of the power supply provides a pulse-width modulation signal to control a power converter. The method includes the following steps: (a3) an output voltage of the power converter is detected to produce a feedback voltage; (b3) at least two burst-in voltages and at least one burst-out voltage are set to provide a first burst-in voltage, a second burst-in voltage, and a burst-out voltage; wherein a voltage level of the burst-out voltage is greater than a voltage level of the first burst-in voltage and the voltage level of the first burst-in voltage is greater than a voltage level of the second burst-in voltage; (c3) the pulse-width modulation signal is switched off when the feedback voltage is less than the second burst-in voltage; (d3) the pulse-width modulation signal is turned on when the feedback voltage is greater than the burst-out voltage; and (e3) the pulse-width modulation signal is switched off when the feedback voltage is less than the first burst-in voltage.

The voltage level of the first burst-in voltage and the voltage level of the second burst-in voltage are set to achieve an arbitrary duty cycle of the pulse-width modulation signal, thus dispersing low-frequency operation energy of the pulse-width modulation signal to reduce audible noise of the power supply.

Further another object of the invention is to provide a power supply to solve the above-mentioned problems.

Accordingly, the power supply includes a transformer, a switch unit, and a control unit. The transformer has a primary-side winding, a secondary-winding winding, and an auxiliary winding. The switch unit is electrically connected to the primary-side winding of the transformer. The control unit is electrically connected to the switch unit and the auxiliary winding of the transformer.

The control unit is configured to detect an output voltage produced from the secondary-side winding to produce a feedback voltage; the control unit is configured to turn on or turn off the switch unit to control a pulse-width modulation signal according to the feedback voltage, thus dispersing low-frequency operation energy of the pulse-width modulation signal to reduce audible noise of the power supply.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

FIG. 1A is a schematic waveform of a prior art converter under a frequency reduction operation according to a first embodiment;

FIG. 1B is a schematic waveform of the prior art converter under the frequency reduction operation according to a second embodiment;

FIG. 2 is a circuit block diagram of a prior art switching power supply;

FIG. 3 is a schematic waveform of timing and voltage of controlling the prior art converter;

FIG. 4 is a schematic view of a prior art burst mode scheme;

FIG. 5 is a schematic view of a burst mode scheme according to a first embodiment of the present disclosure;

FIG. 6 is a schematic view of the dynamic burst mode scheme according to a second embodiment of the present disclosure;

FIG. 7 is a schematic view of the dynamic burst mode scheme according to a third embodiment of the present disclosure;

FIG. 8A is a schematic view of spectrum component of a PWM control signal under a dynamic burst mode operation according to the present disclosure;

FIG. 8B is another schematic view of spectrum component of the PWM control signal under the dynamic burst mode operation according to the present disclosure;

FIG. 8C is further another schematic view of spectrum component of the PWM control signal under the dynamic burst mode operation according to the present disclosure;

FIG. 9A is a flowchart of a method for reducing audible noise of a power supply according to a first embodiment of the present disclosure;

FIG. 9B is a flowchart of a method for reducing audible noise of the power supply according to a second embodiment of the present disclosure;

FIG. 9C is a flowchart of a method for reducing audible noise of the power supply according to a third embodiment of the present disclosure;

FIG. 10A is a schematic circuit block diagram of a PWM control unit of the power supply according to a first embodiment of the present disclosure;

FIG. 10B is a schematic circuit block diagram of a PWM control unit of the power supply according to a second embodiment of the present disclosure; and

FIG. 10C is a schematic circuit block diagram of a PWM control unit of the power supply according to a third embodiment of the present disclosure.

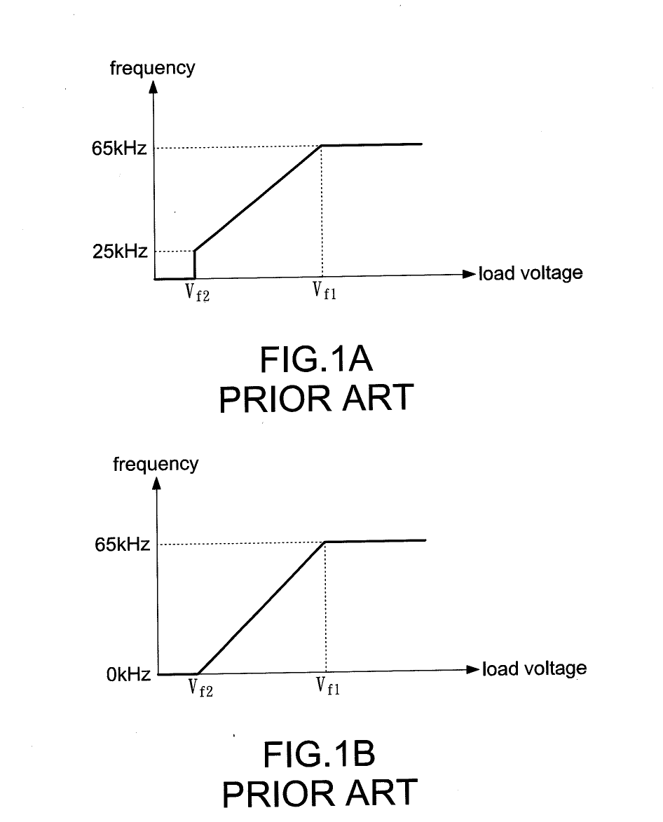

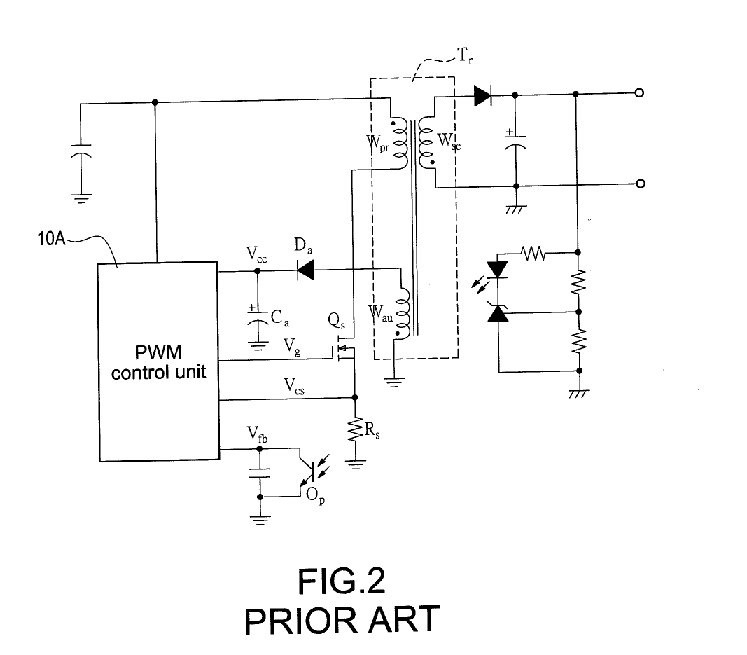

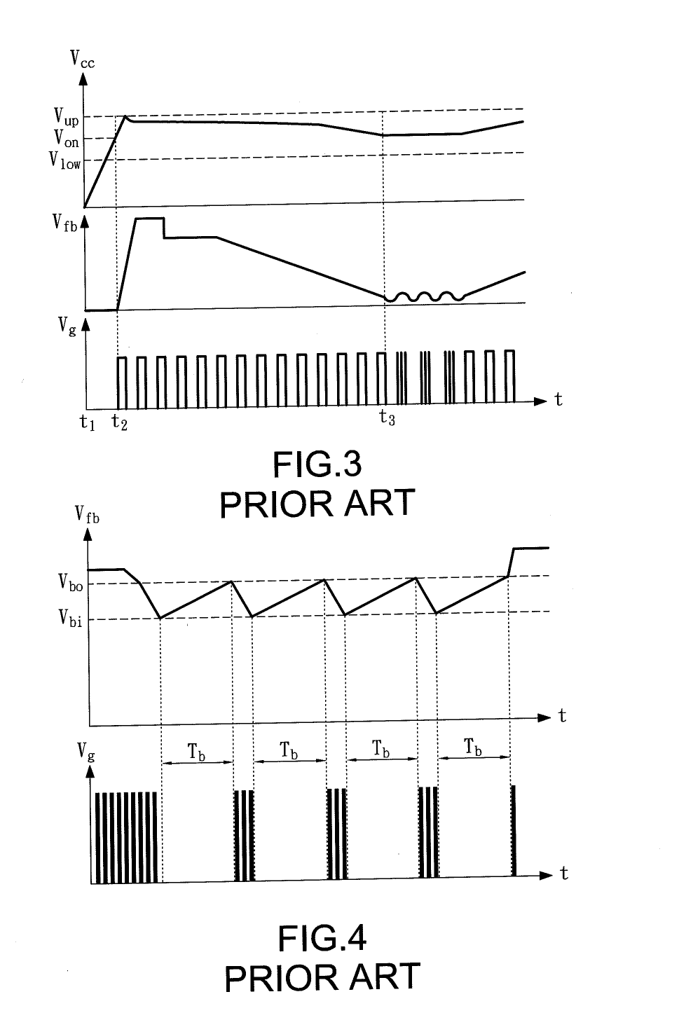

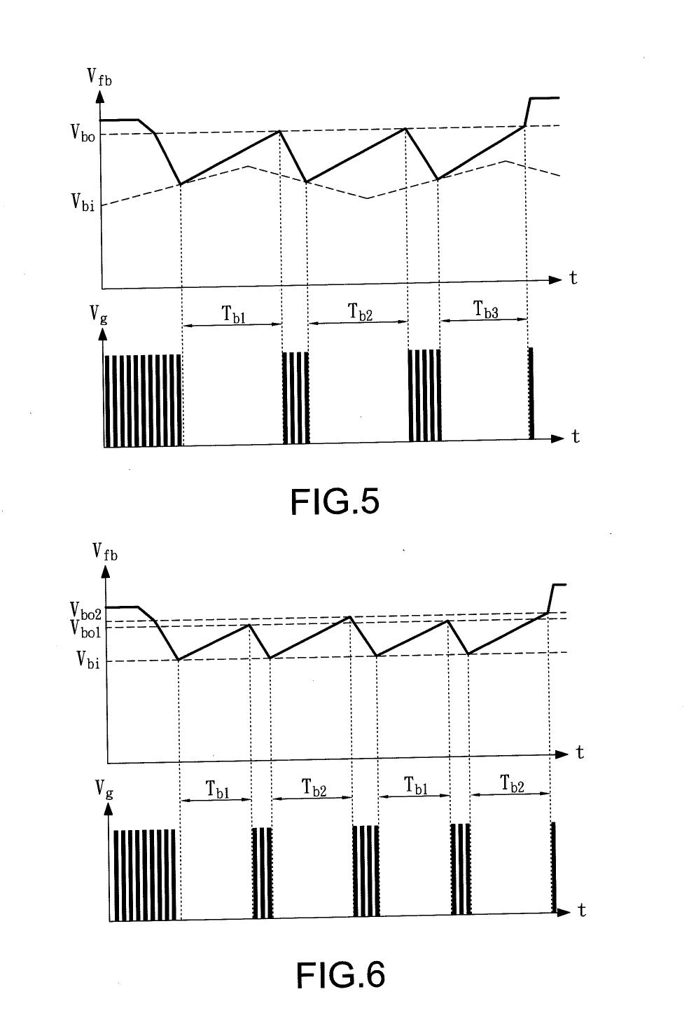

### DETAILED DESCRIPTION

Reference will now be made to the drawing figures to describe the present disclosure in detail.

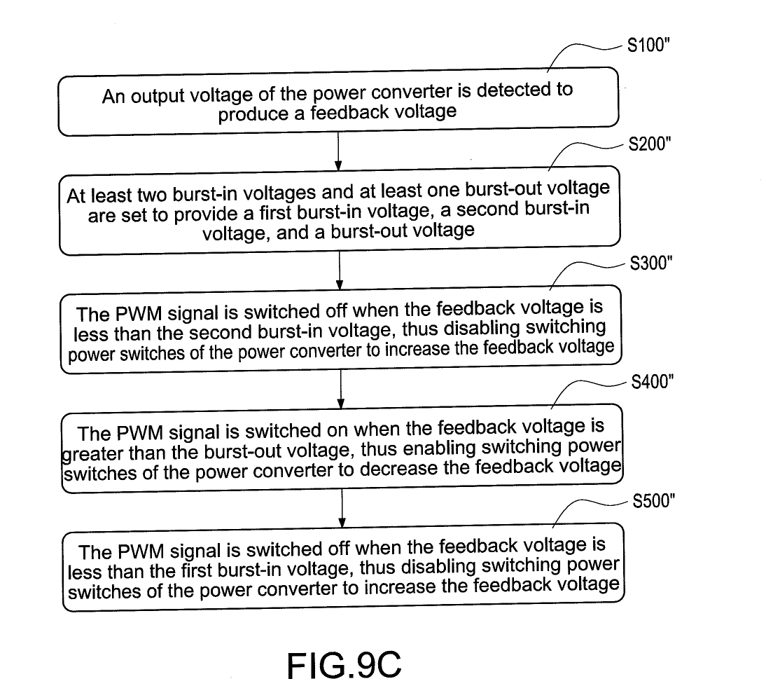

Reference is made to FIG. 9A which is a flowchart of a method for reducing audible noise of a power supply according to a first embodiment of the present disclosure. The method provides a pulse-width modulation (PWM) signal to control a power converter. In particular, the PWM signal can be controlled by a burst mode scheme or a skip mode scheme. In this example, the burst mode scheme is exemplified hereinafter to further demonstrate the method of reducing audible noise of the power supply.

The method of reducing audible noise of the power supply includes the following steps: First, an output voltage of the power converter is detected to produce a feedback voltage (S 100). In particular, the feedback voltage is produced by feeding back the output voltage via a photo coupler, a transformer, or a current transformer, but is not limited to the specific example. Afterward, a burst-in voltage and a burst-out voltage are set (S200). Afterward, a voltage level of the burst-in voltage or a voltage level of the burst-out voltage is dynamically varied (S300). In particular, the level variations of the burst-in voltage and the burst-out voltage are provided by controlling frequency jitter in the PWM signals. Also, the frequency jitter is produced by a random manner. Afterward, the PWM signal is switched off when the feedback voltage is less than the burst-in voltage, thus disabling switching power switches of the power converter to increase the feedback voltage (S400). Finally, the PWM signal is switched on when the feedback voltage is greater than the burst-out voltage, thus enabling switching power switches of the power converter to decrease the feedback voltage (S500). The voltage level of the burst-in voltage or the voltage level of the burst-out voltage are dynamically varied to achieve an arbitrary duty cycle of the pulse-width modulation signal, thus dispersing low-frequency operation energy of the pulse-width modulation signal to reduce audible noise of the power supply.

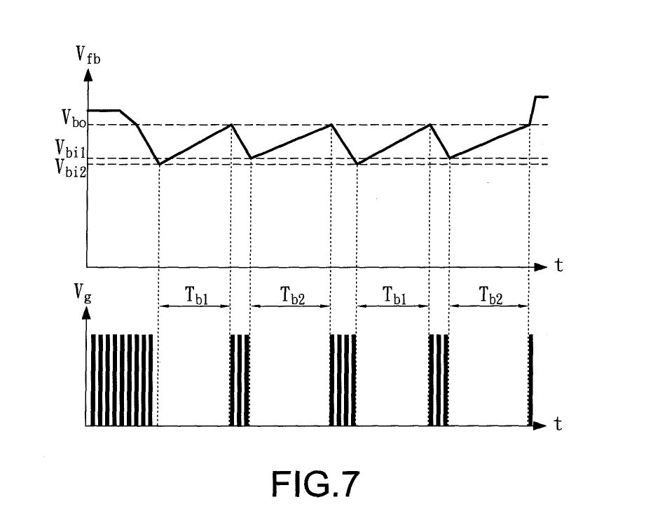

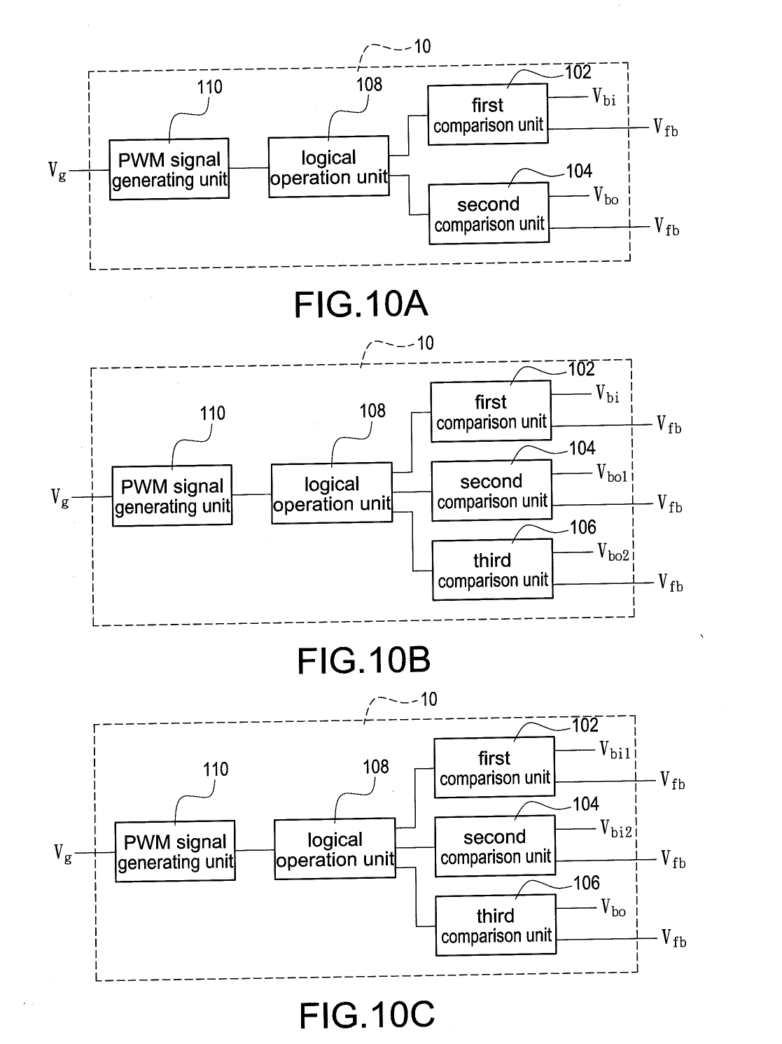

Reference is made to FIG. 5 which is a schematic view of a burst mode scheme according to a first embodiment of the present disclosure. FIG. 5 shows a schematic view of variation of a feedback voltage Vfb and a corresponding PWM control signal Vg under a certain load. In particular, the feedback voltage Vfb is varied with the load conditions. When the feedback voltage Vfb is less than a burst-in voltage Vbi because of the load reduction, a PWM control unit (as shown in FIG. 10A) stops outputting the PWM control signal Vg, thus disabling switching power switches to reduce output power. Accordingly, the feedback voltage Vfb gradually increases. Until the feedback voltage Vfb is greater than a burst-out voltage Vbo, the PWM control unit outputs the PWM control signal Vg so that the feedback voltage Vfb gradually decreases.

Reference is made to FIG. 10A which is a schematic circuit block diagram of a PWM control unit of the power supply according to a first embodiment of the present disclosure. In this embodiment, the PWM control unit 10 includes a first comparison unit 102, a second comparison unit 104, a logical operation unit 108, and a PWM signal generating unit 110.

The first comparison unit 102 and the second comparison unit 104 receive the feedback voltage Vfb, respectively. In addition, the first comparison unit 102 receives the burst-in voltage Vbi and the second comparison unit 104 receives the burst-out voltage Vbo. As previously stated, when the feedback voltage Vfb is less than the burst-in voltage Vbi because of the load reduction, the logical operation unit 108 is mainly controlled by an output of the first comparison unit 102. Accordingly, the logical operation unit 108 produces a disable signal (not shown) to control the PWM signal generating unit 110 stops outputting the PWM control signal Vg, thus disabling switching power switches to reduce output power. Accordingly, the feedback voltage Vfb gradually increases. Until the feedback voltage Vfb is greater than the burst-out voltage Vbo, the logical operation unit 108 is mainly controlled by an output of the second comparison unit 104 to produce an enable signal (not shown) to control the PWM signal generating unit 110 outputting the PWM control signal Vg so that the feedback voltage Vfb gradually decreases.

Especially, the logical operation unit 108 can be an AND gate, an OR gate, a NAND gate, a NOR gate, or a combination of the above-mentioned components. However, the embodiments are only examples and are not intended to limit the scope of the disclosure.

Especially, in this disclosure, the burst mode control scheme and a frequency jitter scheme are integrated to reduce audible noise of the power supply. In particular, the frequency jitter scheme is produced by regularly perturb an internal oscillation frequency of an oscillator of the PWM control unit 10 so that the oscillation frequency has regular slight changes. As shown in FIG. 5, the frequency jitter scheme is introduced to control the burst-in voltage Vbi so as to produce non-fixed burst-in voltage Vbi with variable voltage values. In addition, in this embodiment, the burst-out voltage Vbo is a fixed voltage. Furthermore, not only the burst-in voltage Vbi is controlled by the frequency jitter scheme but also the burst-out voltage Vbo can be controlled (or both the burst-in voltage Vbi and the burst-out voltage Vbo are controlled) to produce non-fixed burst-out voltage Vbo. For convenience of explanation, however, the control of the burst-in voltage Vbi is exemplified for further demonstration.

The PWM signal generating unit 110 stops outputting the PWM control signal Vg, thus disabling switching power switches to reduce output power when the feedback voltage Vfb is less than the burst-in voltage Vbi because of the load reduction. Accordingly, the feedback voltage Vfb gradually increases. Until the feedback voltage Vfb is greater than the burst-out voltage Vbo, the PWM signal generating unit 110 outputs the PWM control signal Vg again so that the feedback voltage Vfb gradually decreases. Accordingly, the feedback voltage Vfb is repeatedly varied between the burst-in voltage Vbi and the burst-out voltage Vbo when the power converter is operated under the light-load condition or the no-load standby condition. Because the burst-in voltage Vbi are varied voltage values, a period Tb1, a period Tb2, and a period Tb3 are not identical when the feedback voltage Vfb is between the burst-in voltage Vbi and the burst-out voltage Vbo. Hence, the dynamic period variations are different from the prior art period variations. Therefore, the corresponding frequencies are not in fixed values, resulting in that the signal spectrum component is usually not focused on the repeating operating frequency. Accordingly, this signal frequency spectrum component is dispersed in a greater frequency range so that the signal amplitude is significantly reduced.

Especially, the frequency jitter can be produced by a random table if the burst mode control is applied to the digital control so that the voltage level of the burst-in voltage or the voltage level of the burst-out voltage are dynamically varied to achieve an arbitrary duty cycle of the pulse-width modulation signal, thus dispersing low-frequency operation energy of the pulse-width modulation signal to reduce audible noise of the power supply.

Reference is made to FIG. 9B which is a flowchart of a method for reducing audible noise of a power supply according to a second embodiment of the present disclosure. The method provides a pulse-width modulation (PWM) signal to control a power converter and the method includes the following steps: First, an output voltage of the power converter is detected to produce a feedback voltage (S100′). In particular, the feedback voltage is produced by feeding back the output voltage via a photo coupler, a transformer, or a current transformer, but is not limited to the specific example. Afterward, at least two burst-out voltages and at least one burst-in voltage are set to provide a first burst-out voltage, a second burst-out voltage, and a burst-in voltage (S200′). In particular, a voltage level of the burst-in voltage is less than a voltage level of the first burst-out voltage and the voltage level of the first burst-out voltage is less than a voltage level of the second burst-out voltage. Afterward, the PWM signal is switched off when the feedback voltage is less than the burst-in voltage, thus disabling switching power switches of the power converter to increase the feedback voltage (S300′). Afterward, the PWM signal is switched on when the feedback voltage is greater than the first burst-out voltage, thus enabling switching power switches of the power converter to decrease the feedback voltage (S400′). Finally, the PWM signal is switched on when the feedback voltage is greater than the second burst-out voltage, thus enabling switching power switches of the power converter to decrease the feedback voltage (S500′). The voltage level of the first burst-out voltage and the voltage level of the second burst-out voltage are set to achieve an arbitrary duty cycle of the pulse-width modulation signal, thus dispersing low-frequency operation energy of the pulse-width modulation signal to reduce audible noise of the power supply.

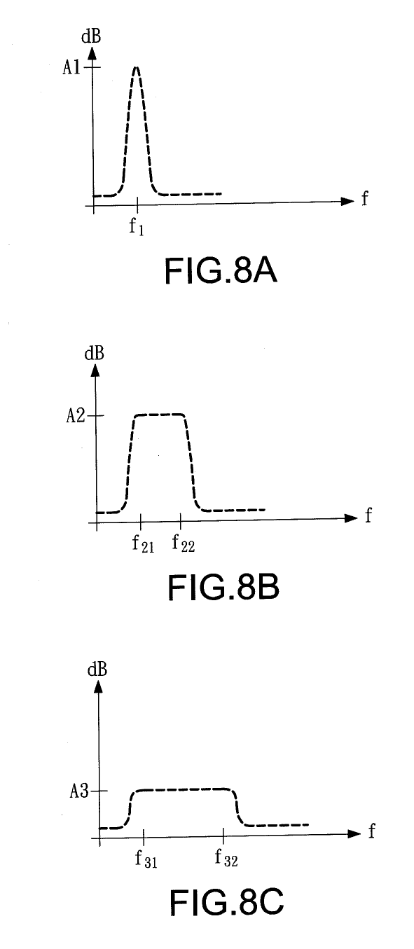

Reference is made to FIG. 6 which is a schematic view of the dynamic burst mode scheme according to a second embodiment of the present disclosure. The present disclosure further provides a burst mode control scheme and at least two burst-out voltages Vbo and a burst-in voltage Vbi are set, but are not limited to the specific example. In this embodiment, two burst-out voltages Vbo are exemplified for further demonstration, namely, a first burst-out voltage Vbo1 and a second burst-out voltage Vbo2. In addition, the burst-in voltage Vbi is a fixed voltage. When the feedback voltage Vfb is less than the burst-in voltage Vbi because of the load reduction, the PWM control unit 10 stops outputting the PWM control signal Vg, thus disabling switching power switches to reduce output power. Accordingly, the feedback voltage Vfb gradually increases. Until the feedback voltage Vfb is greater than the first burst-out voltage Vbo1, the PWM control unit 10 outputs the PWM control signal Vg again so that the feedback voltage Vfb gradually decreases. Until the feedback voltage Vfb is less than the burst-in voltage Vbi again, the PWM control unit 10 stops outputting the PWM control signal Vg so that the feedback voltage Vfb gradually increases. Until the feedback voltage Vfb is greater than the second burst-out voltage Vbo2 again, the PWM control unit 10 outputs the PWM control signal Vg so that the feedback voltage Vfb gradually decreases. Accordingly, the feedback voltage Vfb is repeatedly varied between the burst-in voltage Vbi and the first burst-out voltage Vbo1 or between the burst-in voltage Vbi and the second burst-out voltage Vbo2. In this embodiment, when the feedback voltage Vfb reaches the first burst-out voltage Vbo1 and the second burst-out voltage Vbo2 once, it is deemed as a dynamic control cycle. Because the first burst-out voltage Vbo1 and the second burst-out voltage Vbo2 are two-order variable voltage values, the period Tb1 (the feedback voltage Vfb is between the burst-in voltage Vbi and the first burst-out voltage Vbo1) is not identical to the period Tb2 (the feedback voltage Vfb is between the burst-in voltage Vbi and the second burst-out voltage Vbo2). Therefore, the corresponding frequencies are not in fixed values, resulting in that the signal spectrum component is usually not focused on the repeating operating frequency. Accordingly, this signal frequency spectrum component is dispersed in a greater frequency range so that the signal amplitude is significantly reduced. However, the present disclosure is not limited to the second-order setting, namely, the first burst-in voltage Vbi1 and the second burst-in voltage Vbi2. Furthermore, more the burst-in voltages (Vbi1˜Vbin), more the burst-out voltages (Vbo1˜Vbon), or combination of more the burst-in voltages and more the burst-out voltages (Vbi1˜Vbin, Vbo1˜Vbon) can be set to achieve a multi-order dynamic burst mode scheme.

Reference is made to FIG. 10B which is a schematic circuit block diagram of a PWM control unit of the power supply according to a second embodiment of the present disclosure. In this embodiment, the PWM control unit 10 includes a first comparison unit 102, a second comparison unit 104, a logical operation unit 108, and a PWM signal generating unit 110.

The first comparison unit 102, the second comparison unit 104, and the third comparison unit 106 receive the feedback voltage Vfb, respectively. In addition, the first comparison unit 102 receives the burst-in voltage Vbi, the second comparison unit 104 receives the first burst-out voltage Vbo1, and the third comparison unit 106 receives the second burst-out voltage Vbo2. As previously stated, when the feedback voltage Vfb is less than the burst-in voltage Vbi because of the load reduction, the logical operation unit 108 is mainly controlled by an output of the first comparison unit 102. Especially, the logical operation unit 108 can be an AND gate, an OR gate, a NAND gate, or a NOR gate, but is not limited to the specific example. The logical operation unit 108 produces a disable signal (not shown) to control the PWM signal generating unit 110 to stop outputting the PWM control signal Vg, thus disabling switching power switches to reduce output power. Accordingly, the feedback voltage Vfb gradually increases. Until the feedback voltage Vfb is greater than the first burst-out voltage Vbo1, the logical operation unit 108 is mainly controlled by an output of the second comparison unit 104 to produce an enable signal (not shown) to control the PWM signal generating unit 110 outputting the PWM control signal Vg so that the feedback voltage Vfb gradually decreases.

Until the feedback voltage Vfb is less than the burst-in voltage Vbi again, the PWM signal generating unit 110 stops outputting the PWM control signal Vg so that the feedback voltage Vfb gradually increases. Until the feedback voltage Vfb is greater than the second burst-out voltage Vbo2, the logical operation unit 108 is mainly controlled by an output of the third comparison unit 106 to produce an enable signal (not shown) to control the PWM signal generating unit 110 outputting the PWM control signal Vg so that the feedback voltage Vfb gradually decreases. Accordingly, the feedback voltage Vfb is repeatedly varied between the burst-in voltage Vbi and the first burst-out voltage Vbo1 or between the burst-in voltage Vbi and the second burst-out voltage Vbo2.

Especially, the logical operation unit 108 can be an AND gate, an OR gate, a NAND gate, a NOR gate, or a combination of the above-mentioned components. However, the embodiments are only examples and are not intended to limit the scope of the disclosure.

Reference is made to FIG. 9C which is a flowchart of a method for reducing audible noise of a power supply according to a third embodiment of the present disclosure. The method provides a pulse-width modulation (PWM) signal to control a power converter and the method includes the following steps: First, an output voltage of the power converter is detected to produce a feedback voltage (S 100″). In particular, the feedback voltage is produced by feeding back the output voltage via a photo coupler, a transformer, or a current transformer, but is not limited to the specific example. Afterward, at least two burst-in voltages and at least one burst-out voltage are set to provide a first burst-in voltage, a second burst-in voltage, and a burst-out voltage (S200″). In particular, a voltage level of the burst-out voltage is greater than a voltage level of the first burst-in voltage and the voltage level of the first burst-in voltage is greater than a voltage level of the second burst-in voltage. Afterward, the PWM signal is switched off when the feedback voltage is less than the second burst-in voltage, thus disabling switching power switches of the power converter to increase the feedback voltage (S300″). Afterward, the PWM signal is switched on when the feedback voltage is greater than the burst-out voltage, thus enabling switching power switches of the power converter to decrease the feedback voltage (S400″). Finally, the PWM signal is switched off when the feedback voltage is less than the first burst-in voltage, thus disabling switching power switches of the power converter to increase the feedback voltage (S500″). The voltage level of the first burst-in voltage and the voltage level of the second burst-in voltage are set to achieve an arbitrary duty cycle of the pulse-width modulation signal, thus dispersing low-frequency operation energy of the pulse-width modulation signal to reduce audible noise of the power supply.

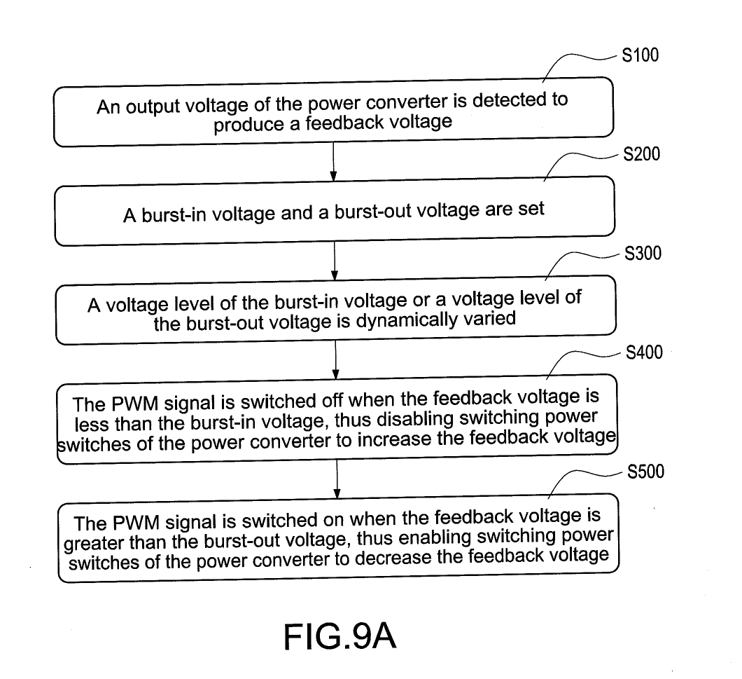

Reference is made to FIG. 7 which is a schematic view of the dynamic burst mode scheme according to a third embodiment of the present disclosure. The present disclosure further provides a burst mode control scheme and at least two burst-in voltages Vbi and a burst-out voltage Vbo are set, but are not limited to the specific example. In this embodiment, two burst-in voltages Vbi are exemplified for further demonstration, namely, a first burst-in voltage Vbi1 and a second burst-in voltage Vbi2. In addition, the burst-out voltage Vbo is a fixed voltage. When the feedback voltage Vfb is less than the second burst-in voltage Vbi2 because of the load reduction, the PWM control unit 10 stops outputting the PWM control signal Vg, thus disabling switching power switches to reduce output power. Accordingly, the feedback voltage Vfb gradually increases. Until the feedback voltage Vfb is greater than the burst-out voltage Vbo, the PWM control unit 10 outputs the PWM control signal Vg again so that the feedback voltage Vfb gradually decreases. Until the feedback voltage Vfb is less than the first burst-in voltage Vbi1 again, the PWM control unit 10 stops outputting the PWM control signal Vg so that the feedback voltage Vfb gradually increases. Until the feedback voltage Vfb is greater than the burst-out voltage Vbo again, the PWM control unit 10 outputs the PWM control signal Vg so that the feedback voltage Vfb gradually decreases. Accordingly, the feedback voltage Vfb is repeatedly varied between the burst-out voltage Vbo and the first burst-in voltage Vbi1 or between the burst-out voltage Vbo and the second burst-in voltage Vbi2. In this embodiment, when the feedback voltage Vfb reaches the first burst-in voltage Vbi1 and the second burst-in voltage Vbi2 once, it is deemed as a dynamic control cycle. Because the first burst-in voltage Vbi1 and the second burst-in voltage Vbi2 are two-order variable voltage values, the period Tb1 (the feedback voltage Vfb is between the burst-out voltage Vbo and the second burst-in voltage Vbi2) is not identical to the period Tb2 (the feedback voltage Vfb is between the burst-out voltage Vbo and the first burst-in voltage Vbi1). Therefore, the corresponding frequencies are not in fixed values, resulting in that the signal spectrum component is usually not focused on the repeating operating frequency. Accordingly, this signal frequency spectrum component is dispersed in a greater frequency range so that the signal amplitude is significantly reduced. However, the present disclosure is not limited to the second-order setting, namely, the first burst-in voltage Vbi1 and the second burst-in voltage Vbi2. Furthermore, more the burst-in voltages (Vbi1˜Vbin), more the burst-out voltages (Vbo1˜Vbon), or combination of more the burst-in voltages and more the burst-out voltages (Vbi1˜Vbin, Vbo1˜Vbon) can be set to achieve a multi-order dynamic burst mode scheme.

Reference is made to FIG. 10C which is a schematic circuit block diagram of a PWM control unit of the power supply according to a third embodiment of the present disclosure. In this embodiment, the PWM control unit 10 includes a first comparison unit 102, a second comparison unit 104, a logical operation unit 108, and a PWM signal generating unit 110.

The first comparison unit 102, the second comparison unit 104, and the third comparison unit 106 receive the feedback voltage Vfb, respectively. In addition, the first comparison unit 102 receives the first burst-in voltage Vbi1, the second comparison unit 104 receives the second burst-in voltage Vbi2, and the third comparison unit 106 receives the burst-out voltage Vbo. As previously stated, when the feedback voltage Vfb is less than the second burst-in voltage Vbi2 because of the load reduction, the logical operation unit 108 is mainly controlled by an output of the second comparison unit 104. The logical operation unit 108 produces a disable signal (not shown) to control the PWM signal generating unit 110 to stop outputting the PWM control signal Vg, thus disabling switching power switches to reduce output power. Accordingly, the feedback voltage Vfb gradually increases. Until the feedback voltage Vfb is greater than the burst-out voltage Vbo, the logical operation unit 108 is mainly controlled by an output of the third comparison unit 106 to produce an enable signal (not shown) to control the PWM signal generating unit 110 outputting the PWM control signal Vg so that the feedback voltage Vfb gradually decreases.

Until the feedback voltage Vfb is less than the first burst-in voltage Vbi1 again, the logical operation unit 108 is mainly controlled by an output of the first comparison unit 102 to produce a disable signal (not shown) controlling the PWM signal generating unit 110 to stop outputting the PWM control signal Vg so that the feedback voltage Vfb gradually increases. Until the feedback voltage Vfb is greater than the burst-out voltage Vbo again, the PWM signal generating unit 110 outputs the PWM control signal Vg so that the feedback voltage Vfb gradually decreases. Accordingly, the feedback voltage Vfb is repeatedly varied between the burst-out voltage Vbo and the first burst-in voltage Vbi1 or between the burst-out voltage Vbo and the second burst-in voltage Vbi2.

Especially, the logical operation unit 108 can be an AND gate, an OR gate, a NAND gate, a NOR gate, or a combination of the above-mentioned components. However, the embodiments are only examples and are not intended to limit the scope of the disclosure.

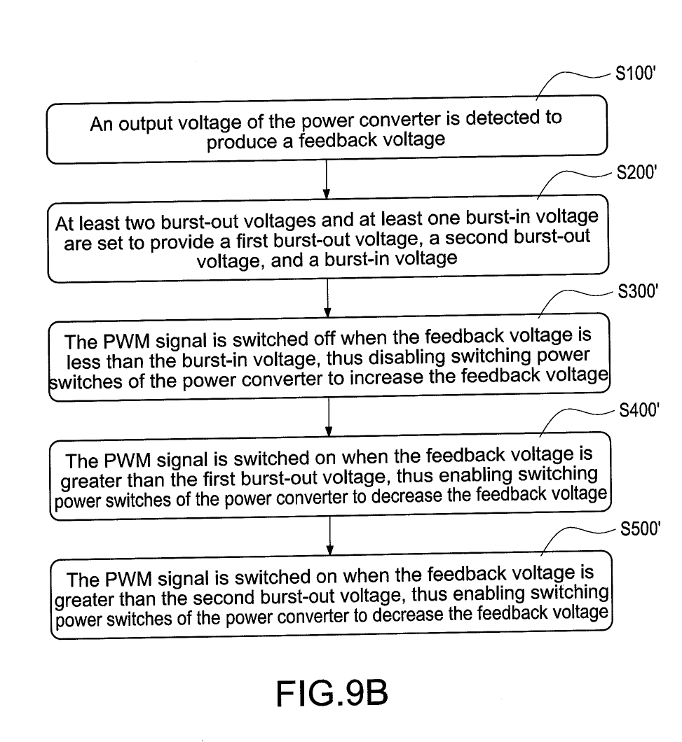

Reference is made to FIG. 8A to FIG. 8C which are different schematic views of spectrum component of the PWM control signal under the dynamic burst mode operation according to the present disclosure. FIG. 8A shows that the power supply is operated under the repeating operating frequency, resulting in that the signal spectrum component is focused on the repeating operating frequency f1. Hence, amplitude A1 of the frequency f1 is particularly large. In contrast to FIG. 8A, FIG. 8B and the FIG. 8C show that the dispersed spectrum components are produced under the operations of integrating the burst mode scheme and the frequency jitter scheme. As shown in FIG. 8B, a signal amplitude A2 in a frequency interval f21-f22 is reduced comparing to that in FIG. 8A; also, a signal amplitude A3 in a frequency interval f31-f32 as shown in FIG. 8C is significantly reduced compared to that in FIG. 8A. That is, the signal amplitude A3 is less than the signal amplitude A2 and the signal amplitude A2 is also less than the signal amplitude A1 (A3<A2<A1). Furthermore, even if the frequency of the PWM control signal Vg falls in the frequency range that the human can hear, the influence on the human ear can also greatly reduce as the signal amplitude will be greatly reduced. Therefore, the low-frequency operation energy of the pulse-width modulation signal is dispersed to reduce audible noise of the power supply by the burst mode control scheme, thus effectively improving performance and meeting energy-saving of the power supply.

Although several embodiments of the present disclosure have been described in detail, it will be understood that the disclosure is not limited to such details. Various substitutions will occur to those of ordinary skill in the art of the foregoing description. Therefore, all such substitutions and modifications are intended to be embraced within the scope of this disclosure.

What is claimed is:

1. A method of reducing audible noise of a power supply for providing a pulse-width modulation signal to control a power converter; steps of the method comprising:
(a1) detecting an output voltage of the power converter to produce a feedback voltage;
(b1) setting a burst-in voltage and a burst-out voltage;
(c1) dynamically varying a voltage level of the burst-in voltage or a voltage level of the burst-out voltage;
(d1) switching off the pulse-width modulation signal when the feedback voltage is less than the burst-in voltage; and
(e1) switching on the pulse-width modulation signal when the feedback voltage is greater than the burst-out voltage;
wherein the voltage level of the burst-in voltage or the voltage level of the burst-out voltage are dynamically varied to achieve an arbitrary duty cycle of the pulse-width modulation signal, thus dispersing low-frequency operation energy of the pulse-width modulation signal to reduce audible noise of the power supply.

2. The method of reducing audible noise in claim 1, wherein in step (c1), the voltage level of the burst-in voltage and the voltage level of the burst-out voltage are provided by controlling frequency jitter in the pulse-width modulation signal.

3. The method of reducing audible noise in claim 2, wherein in step (c1), the frequency jitter is produced by a random table.

4. The method of reducing audible noise in claim 1, wherein in step (a1), the feedback voltage is produced by feeding back the output voltage via a photo coupler, a transformer, or a current transformer.

5. The method of reducing audible noise in claim 1, wherein in step (d1), the feedback voltage increases when the pulse-width modulation signal is switched off; in step (e1), the feedback voltage decreases when the pulse-width modulation signal is switched on.

6. A method of reducing audible noise of a power supply for providing a pulse-width modulation signal to control a power converter; steps of the method comprising:
(a2) detecting an output voltage of the power converter to produce a feedback voltage;
(b2) setting at least two burst-out voltages and at least one burst-in voltage to provide a first burst-out voltage, a second burst-out voltage, and a burst-in voltage; wherein a voltage level of the burst-in voltage is less than a voltage level of the first burst-out voltage and the voltage level of the first burst-out voltage is less than a voltage level of the second burst-out voltage;
(c2) switching off the pulse-width modulation signal when the feedback voltage is less than the burst-in voltage;
(d2) switching on the pulse-width modulation signal when the feedback voltage is greater than the first burst-out voltage; and
(e2) switching on the pulse-width modulation signal when the feedback voltage is greater than the second burst-out voltage;
wherein the voltage level of the first burst-out voltage and the voltage level of the second burst-out voltage are set to achieve an arbitrary duty cycle of the pulse-width modulation signal, thus dispersing low-frequency operation energy of the pulse-width modulation signal to reduce audible noise of the power supply.

7. The method of reducing audible noise in claim 6, wherein in step (a2), the feedback voltage is produced by feeding back the output voltage via a photo coupler, a transformer, or a current transformer.

8. The method of reducing audible noise in claim 6, wherein in step (c2), the feedback voltage increases when the pulse-width modulation signal is switched off; in step (d2) and step (e2), the feedback voltage decreases when the pulse-width modulation signal is switched on.

9. A method of reducing audible noise of a power supply for providing a pulse-width modulation signal to control a power converter; steps of the method comprising:
(a3) detecting an output voltage of the power converter to produce a feedback voltage;
(b3) setting at least two burst-in voltages and at least one burst-out voltage to provide a first burst-in voltage, a second burst-in voltage, and a burst-out voltage; wherein a voltage level of the burst-out voltage is greater than a voltage level of the first burst-in voltage and the voltage level of the first burst-in voltage is greater than a voltage level of the second burst-in voltage;
(c3) switching off the pulse-width modulation signal when the feedback voltage is less than the second burst-in voltage;
(d3) switching on the pulse-width modulation signal when the feedback voltage is greater than the burst-out voltage; and
(e3) switching off the pulse-width modulation signal when the feedback voltage is less than the first burst-in voltage;
wherein the voltage level of the first burst-in voltage and the voltage level of the second burst-in voltage are set to achieve an arbitrary duty cycle of the pulse-width modulation signal, thus dispersing low-frequency operation energy of the pulse-width modulation signal to reduce audible noise of the power supply.

10. The method of reducing audible noise in claim 9, wherein in step (a3), the feedback voltage is produced by feeding back the output voltage via a photo coupler, a transformer, or a current transformer.

11. The method of reducing audible noise in claim 9, wherein in step (c3) and step (e3), the feedback voltage increases when the pulse-width modulation signal is switched off; in step (d3), the feedback voltage decreases when the pulse-width modulation signal is switched on.

12. A power supply comprising:
a transformer having a primary-side winding, a secondary-side winding, and an auxiliary winding;
a switch unit electrically connected to the primary-side winding of the transformer; and
a control unit electrically connected to the switch unit and the auxiliary winding of the transformer;
wherein the control unit is configured to detect an output voltage produced from the secondary-side winding to produce a feedback voltage; the control unit is configured to turn on or turn off the switch unit to control a pulse-width modulation signal according to the feedback voltage, thus dispersing low-frequency operation energy of the pulse-width modulation signal to reduce audible noise of the power supply.

13. The power supply in claim 12, wherein the feedback voltage is compared to a burst-in voltage and a burst-out voltage to switch off or switch on the pulse-width modulation signal.

14. The power supply in claim 13, wherein the voltage level of the burst-in voltage or the voltage level of the burst-out voltage are dynamically varied to achieve an arbitrary duty cycle of the pulse-width modulation signal, thus dispersing low-frequency operation energy of the pulse-width modulation signal to reduce audible noise of the power supply; wherein the pulse-width modulation signal is switched off when the feedback voltage is less than the burst-in voltage and the pulse-width modulation signal is switched on when the feedback voltage is greater than the burst-out voltage.

15. The power supply in claim 12, wherein the feedback voltage is compared to at least two burst-out voltages and at least one burst-in voltage to switch off or switch on the pulse-width modulation signal; wherein the two burst-out voltages are a first burst-out voltage and a second burst-out voltage; a voltage level of the burst-in voltage is less than a voltage level of the first burst-out voltage and the voltage level of the first burst-out voltage is less than a voltage level of the second burst-out voltage.

16. The power supply in claim 15, wherein the voltage level of the first burst-out voltage and the voltage level of the second burst-out voltage are set to achieve an arbitrary duty cycle of the pulse-width modulation signal, thus dispersing low-frequency operation energy of the pulse-width modulation signal to reduce audible noise of the power supply; wherein the pulse-width modulation signal is switched off when the feedback voltage is less than the burst-in voltage, the pulse-width modulation signal is switched on when the feedback voltage is greater than the first burst-out voltage, and the pulse-width modulation signal is switched on when the feedback voltage is greater than the second burst-out voltage.

17. The power supply in claim 12, wherein the feedback voltage is compared to at least two burst-in voltages and at least one burst-out voltage to switch off or switch on the pulse-width modulation signal; wherein the two burst-in voltages are a first burst-in voltage and a second burst-in voltage; a voltage level of the burst-out voltage is greater than a voltage level of the first burst-in voltage and the voltage level of the first burst-in voltage is greater than a voltage level of the second burst-in voltage.

18. The power supply in claim 17, wherein the voltage level of the first burst-in voltage and the voltage level of the second burst-in voltage are set to achieve an arbitrary duty cycle of the pulse-width modulation signal, thus dispersing low-frequency operation energy of the pulse-width modulation signal to reduce audible noise of the power supply; wherein the pulse-width modulation signal is switched off when the feedback voltage is less than the second burst-in voltage, the pulse-width modulation signal is switched on when the feedback voltage is greater than the burst-out voltage, and the pulse-width modulation signal is switched off when the feedback voltage is less than the first burst-in voltage.
